(19) United States
(12) Patent Application Publication
(10) Pub. No.: US 2016/0196489 A1
(43) Pub. Date: Jul. 7, 2016

(54) ARTIFICIAL NEURON

(71) Applicant: PHILIPS LIGHTING HOLDING B.V., Eindhoven (NL)

(72) Inventors: FREDERIC ALEXANDRE GUILLANNEUF, EINDHOVEN (NL); MARCELLINUS PETRUS CAROLUS MICHAEL KRIJN, EINDHOVEN (NL)

(21) Appl. No.: 14/916,127

(22) PCT Filed: Aug. 27, 2014
(86) PCT No.: PCT/EP2014/068163

§ 371 Date: Mar. 2, 2016

(30) Foreign Application Priority Data
Sep. 2, 2013 (EP) 13182579.6

(51) Int. Cl. G06N 3/067

(52) U.S. Cl. CPC G06N 3/067

(57) ABSTRACT

The present invention relates to an optical device (101, 201, 305). The present invention may be implemented as optical artificial neurons. The optical device comprises an optically transmissive light-receiving device (102) which may be a photodiode, an optically transmissive light-emitting device (104, 304) such as a light-emitting diode, an optically transmissive processor (103) comprising a memory storage device (106). The light-emitting device and the light-receiving device are electrically connected to the processor which is configured to control the light-emitting device to emit an optical signal (307, 313) based on a first optical signal received by the light-receiving device. The optical device comprises an address which is transmitted with the optical signal. The address of may be recognized by the processor when processing a received optical signal and is used by the processor to determine to control the light-emitting device to emit an optical signal or not.

### FIELD OF THE INVENTION

The present invention relates to an optical device. In particular, the present invention relates to optical artificial neurons.

### BACKGROUND OF THE INVENTION

The computational power in modern computers has increased dramatically in the past decades. In modern electronic devices, a large number of electronic components are electrically connected for communicating with each other. In some applications, discrete components are mounted on a printed circuit board (PCB) which comprises the required conductive paths for interconnecting the components. For more complex applications where a larger number of components are required, integrated circuits are used where components are made in a semiconductor substrate and where communication between components takes place in different metal layers arranged on the substrate.

Recently, artificial neural networks have been implemented in order to increase the computational power even further. Artificial neural networks can be formed from semiconductor devices where a number of components representing artificial neurons are connected together in a network. The idea is to mimic biological neural systems where a single neuron receives signals from a vast number of other neurons. Depending on a sum of the signals received by a neuron, the neuron determines whether to emit a signal or not. If a signal is emitted, it may in turn be received and processed by other neurons.

In a simulated neural network the number of interconnections between neurons can be substantial. In order to truly mimic e.g. a human brain, about 100 billion neurons are required, where each neuron is connected to about 10 000 other neurons. In semiconductor based artificial neural networks, interconnections between artificial neurons are accomplished using conventional electrically conducting interconnects. As can be understood, the electrical interconnects limit the possible complexity of an artificial neural network.

In U.S. Pat. No. 6,754,646 the wires have been replaced by an optical communication method. This way, the wires may be eliminated. Instead, optical signals are transmitted through optically transparent portions of the device described in U.S. Pat. No. 6,754,646. For example, an optical signal emitted by a light-emitter is guided though a transparent portion of housing for the device. The optical signal may then be received by a light-receiver arranged adjacent to a transparent portion to which the optical signal is guided. However, it would be desirable to further improve communication between optical devices.

### SUMMARY OF THE INVENTION

In view of the above-mentioned and other drawbacks of the prior art, a general object of the present invention is to provide an optical device with more flexible communication between two or more optical devices. Such optical devices may be implemented as optical artificial neurons.

According to a first aspect of the invention there is provided an optical device comprising: an optically transmissive light-emitting device; an optically transmissive light-receiving device; and an optically transmissive control unit electrically connected to the light-emitting device and to the light-receiving device; wherein the control unit is configured to control the light-emitting device to emit an optical signal based on at least one optical signal received by the light-receiving device.

An optically transmissive component is a component that may allow for at least enough of an optical signal to pass through a material of the component such that the optical signal may accurately be received by the light-receiving device. Optically transmissive may be e.g. transparent, semi-transparent, translucent, or combinations thereof. The processing unit determines to control the light-emitting device to emit an optical signal based on properties of optical signals received by the light-receiving device of the optical device.

The present invention is based on the realization that by using components made from optically transmissive materials, a light-emitting device arranged in the optical device may emit optical signals in several directions which enables communication with more than one other light-receiving device. With such an optical device, the components arranged therein may communicate with other optical devices through optical signals which will not be obstructed by the optically transmissive components of the optical devices. The invention enables flexibility in designing a structure and in the layout of an optical device which is independent of the locations of the components within the optical device and the location of other optical devices. Thus, a number of electrical connections between components of the optical device and between optical devices made via physical connections such as wires can be reduced, or even eliminated. In this way, it allows for communication between a plurality of light-emitting and light-receiving devices which are all optically transmissive arranged anywhere among a plurality of optical devices. For example, an optical signal may pass through a material of an optically transmissive light-emitting device which enables further layout possibilities of optical devices. The invention enables a larger number of optical devices to communicate with each other via optical signals. The optical device according to the invention may be regarded as an artificial neuron having an input part being the light-receiving device and an output part being the light-emitting device. The light-receiving part may receive an optical signal from another optical device through a simulated synapse, i.e. a connection between two neurons. The received signal may be processed by the control unit, and depending on properties of the received optical signal, the control unit may control the light-emitting device to emit an optical signal, analogous to a firing biological neuron. Thus, the invention further enables a simplified artificial neural network comprising fewer parts, due to improved communication, than what is known in prior art.

In one embodiment of the present invention, the optical device may further comprise an optically transmissive storage device configured to store a unique address of the optical device. The unique address enables identification of the optical device among a plurality of optical devices. The memory storage device is optically transmissive to further facilitate for propagation of optical signals.

In one embodiment of the present invention, the storage device may further be configured to store a plurality of predefined unique addresses, each address corresponding to a respective optical device. In other words, each optical device has a corresponding address. If an optical device receives an optical signal, the control unit of the optical device may recognize the address of the optical signal to be one of the addresses stored in the memory. In this way, a control unit of an optical device may identify a plurality of other optical devices if the optical device receives an address from another optical device.

According to one embodiment of the present invention, the control unit may be configured to control the light-emitting device to emit an optical signal comprising information identifying the optical device. By including information in an emitted optical signal unique to the optical device which emitted the optical signal, an optical device which receives the optical signal may identify from which optical device the optical signal was emitted. This way, the receiving optical device may determine, based on e.g. which optical device emitted the signal, how to process the received signal.

According to one embodiment of the present invention, if an address of a received optical signal corresponds to one of the plurality of predefined unique addresses, the control unit may be configured to increment accumulated property value by an amount based on a weight of the received optical signal. For example, a first optical device may receive an optical signal comprising an address which is recognized as the address of a second optical device connected to the first optical device. A value of the optical signal comprising the weight is added to an accumulated property value by the control unit.

According to one embodiment of the present invention, if the property value of received values exceeds a threshold value, the control unit is configured to control the light-emitting device to emit an optical signal. In other words, if sufficient optical signals comprising addresses, with corresponding weights, are recognized by the control unit of an optical device and received by the optical device, the control unit of the optical device controls a light-emitting device to emit an optical signal.

According to one embodiment of the present invention, the optical device may be integrated in an optically transmissive medium such that optical signals may be received from all directions by the light-receiving device and such that optical signals may be emitted in all directions by the light-emitting device. In other words optical signals maybe received by and emitted from an optical device omnidirectionally. The optically transmissive enclosure may be made from plastic or glass or any other suitable material.

According to one embodiment of the present invention, the optical device is integrated in a casing comprising an optically opaque portion arranged such that optical signals may be prevented from being received from at least one direction and such that optical signals may be prevented from being emitted in at least one direction. Blocking optical signals propagating in certain direction enables preselected directions of communication.

According to one embodiment of the present invention, a plurality of optical devices may be arranged such that an optical signal may propagate unguided from a first optical device to a second optical device. A plurality of optical devices may thus be arranged such that the optical signal propagates unguided from a light-emitting device to a light-receiving device. In other words, the optical signals are not guided from a first optical device to a second optical device but are emitted by the light-emitting device and may propagate freely through both optically transmissive solid materials and air. Communication via unguided optical signals further eliminates the need for guiding the optical signal through e.g. an optical fiber or using mirrors, thus the complexity of the optical device is reduced. By eliminating or reducing the need for physical connections between components the number of connections may be increased and thus the processing speed of the optical device may be increased with reduced complexity with respect to the number of interconnects.

According to one embodiment of the invention, a plurality of optical devices may be arranged such that an optical signal may propagate unguided from the first optical device to a second optical device through a third optical device. Thus, the optical signal is not obstructed by an optical device arranged in the path of the optical signal. In this way, communication between several optical devices via unguided optical signals is facilitated.

According to one embodiment of the invention, the light-receiving device may advantageously be a solid state phototransistor or photodiode. The light-emitting device may advantageously be a solid state lighting device, in which light is generated through recombination of electrons and holes. Such light-emitting device may advantageously be a light-emitting diode. The optically transmissive light-receiving device is advantageously made from indium-gallium-zinc-oxide. However, the optically transmissive light-receiving device may be made from any other suitable material. In one embodiment of the invention the control unit may comprise an oxide thin film transistor.

According to a second aspect of the invention there is provided a method of controlling an optical device comprising: an optically transmissive light-emitting device; an optically transmissive light-receiving device; and an optically transmissive control unit electrically connected to and configured to control the light-emitting device, the light-receiving device and the storage device; the method comprising the steps of: receiving an optical signal comprising an address identifying a second optical device; determining if the address identifying a second optical device correspond to an address stored in the storage device; and if the address corresponds to the address stored in the storage device, incrementing property value based on a weight of the received optical signal.

According to one embodiment of the invention, if the received property values exceed a threshold value, controlling the light-emitting device to emit an optical signal. Thus, if an accumulated sum of received and recognized optical signals exceeds a predetermined value, the control unit may decide to control the light-emitting device to emit an optical signal that may be received by a light-receiving device of another optical device. The predetermined value may be the sum of weights of optical signals received in a predetermined time interval.

Further features of, and advantages with, the present invention will become apparent when studying the appended claims and the following description. The skilled person realize that different features of the present invention may be combined to create embodiments other than those described in the following, without departing from the scope of the present invention. For example, the optical signal may not necessarily comprise the address but may be transmitted by separate communication means, preferably wireless communication means.

### BRIEF DESCRIPTION OF THE DRAWINGS

These and other aspects of the present invention will now be described in more detail, with reference to the appended drawings showing exemplary embodiments of the invention, wherein:

FIG. 1 schematically illustrates an optical device according to an embodiment of the invention;

FIG. 2 illustrates an optical device according to an embodiment of the invention;

FIG. 3 illustrates a plurality of optical devices according to an embodiment of the invention; and

FIG. 4 illustrates a flow-chart outlining the general steps of a method according to an embodiment of the invention.

### DESCRIPTION OF EXAMPLE EMBODIMENTS OF THE PRESENT INVENTION

In the following description, the present invention is mainly described with reference to an optical device in the form of an optical artificial neuron.

It should, however, be noted that this by no means limits the scope of the invention, which is equally applicable to other applications, such as light equipments, LED lamps, coded light luminaires, mobile phones, watches, heads-up displays, television sets, displays, and games, or other applications where optical communication is applicable.

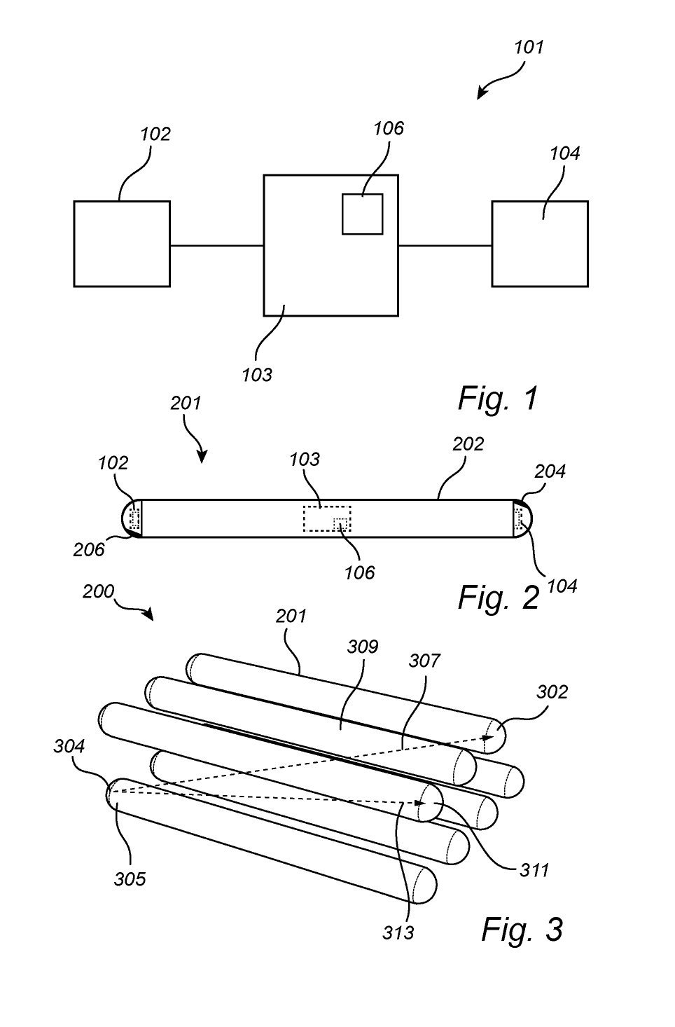

FIG. 1 schematically illustrates an optical device 101 in accordance with the invention. FIG. 1 shows a light-receiving device 102, a processing unit 103, and a light-emitting device 104. The light-receiving device 102 may be a photo-diode and the light-emitting device 104 may be a light-emitting diode. The processing unit 103 is connected to the light-receiving device 102 and to the light-emitting device 104 such that it may control the light-emitting device 104 to emit an optical signal based on an optical signal received by the light-receiving device 102. The light-receiving device 102, the light-emitting device 104 and the processing unit 103 are optically transmissive. The processing unit 103 further comprises an optically transmissive memory storage device 106 where addresses of several other optical devices are stored and a unique address of the optical device 101. The address may be a 36-bit address.

FIG. 2 illustrates a possible layout of an optical device 201 in the form of an optical artificial neuron 201. It comprises the optically transmissive light-receiving device 102, the optically transmissive light-emitting device 104, and the optically transmissive processing unit 103 comprising the memory storage device 106, housed in an optically transmissive medium in the form of an optically transmissive housing 202. The optically transmissive housing 202 and the optically transmissive components 102-104, 106 enable an optical signal to be transmitted from the light-emitting device 104 in all directions and to be received by the light-receiving device 102 from all directions.

Optionally, still with reference to FIG. 2, the housing 202 may be a casing 202 which may be optically transmissive, and having opaque portions 204-206 arranged such that optical signals are blocked in some directions. For example optical signals may be blocked such that they may not be received from certain directions and/or such that they may not be emitted in certain directions. By blocking the optical signals only selected optical devices may communicate with each other.

FIG. 3 illustrates a plurality of optical devices 200 in the form of optical artificial neurons 201 (only one is numbered to avoid cluttering in the drawing) arranged to communicate with each other through optical signals. An optical signal 307 emitted from a light-emitting device 304 of a first optical device 305 propagates unguided and is received by a light-receiving device 302 of a remote second optical device 201. The optical signal propagates through several other optical devices, for example optical device 309 as it propagates from the first optical device 305 to the second optical device 201. Furthermore, the optical signal 307 emitted by the light-emitting device 304 is emitted in all directions. The optical signal 307 therefore also reaches the light-receiving device 311 of optical device 313. This way, communication is enabled in more than one direction, that is, with optical devices arranged in arbitrary locations within the plurality of optical devices 200.

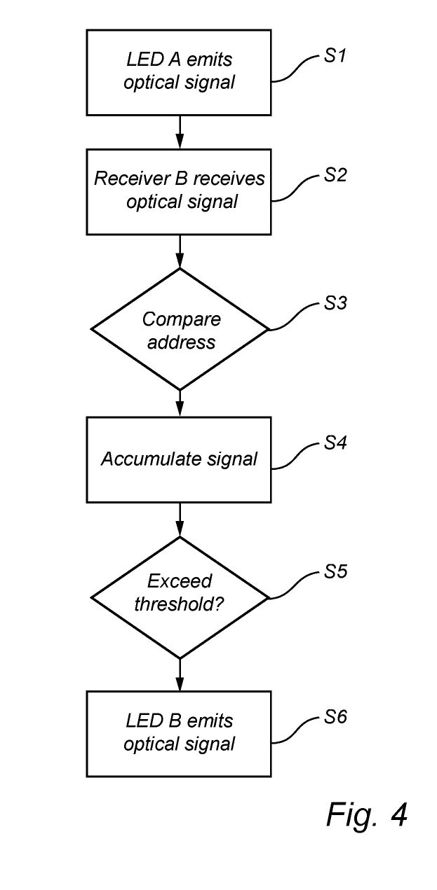

FIG. 4 is a flow chart illustrating the general steps of a method for controlling an optical artificial neuron. In a first step S1 a first artificial neuron emits a coded optical signal comprising a 36 bit address. The optical signal is received in step S2 by a light-receiving device of a second artificial neuron. The address of the signal is compared S3 with existing addresses stored in a memory storage device of the second artificial neuron. If the address exists among the stored addresses in the memory storage device then the received signal is added to an accumulator of the processing unit in step S4. If the address does not exist among the stored addresses, no action is taken. When the accumulator of the processing unit of the second artificial neuron reaches a predetermined threshold value, illustrated by step S5, the processing unit controls the light-emitting device to emit a coded optical signal comprising a 36 bit address in step S6.

Additionally, variations to the disclosed embodiments can be understood and effected by the skilled person in practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

Summarizing, the present invention relates to an optical device 101, 201, 305. The present invention may be implemented as optical artificial neurons. The optical device comprises an optically transmissive light-receiving device 102 which may be a photodiode, an optically transmissive light-emitting device 104, 304 such as a light-emitting diode, an optically transmissive processor 103 comprising a memory storage device 106. The light-emitting device and the light-receiving device are electrically connected to the processor which is configured to control the light-emitting device to emit an optical signal 307, 313 based on a first optical signal received by the light-receiving device. The optical device comprises an address which is transmitted with the optical signal. The address of may be recognized by the processor when processing a received optical signal and is used by the processor to determine to control the light-emitting device to emit an optical signal or not.

1. An optical device comprising:
an optically transmissive light-emitting device configured to allow at least portion of an optical signal to be transmitted through said optically transmissive light-emitting device;
an optically transmissive light-receiving device, wherein said optical signal is received by said optically transmissive light-receiving device and at least a portion of said optical signal is transmitted through said optically transmissive light-receiving device; and
an optically transmissive control unit electrically connected to said light-emitting device and to said light-receiving device, said optically transmissive control unit being configured to allow at least a portion of said optical signal to pass through the optically transmissive control unit;
wherein the control unit is configured to control the light-emitting device to emit an optical signal based on at least said optical signal received by said light-receiving device.

2. The optical device according to claim 1, further comprising an optically transmissive storage device configured to store a unique address of said optical device.

3. The optical device according to claim 1, wherein said storage device is further configured to store a plurality of predefined unique addresses, each address corresponding to a respective optical device.

4. The optical device according to claim 1, wherein said control unit is configured to control said light-emitting device to emit an optical signal comprising information identifying said optical device.

5. The optical device according to claim 3, wherein if an address of a received optical signal corresponds to one of said plurality of predefined unique addresses, said control unit is configured to increment a property value by an amount based on a weight of said received optical signal.

6. The optical device according to claim 5, wherein if said property value exceeds a threshold value, said control unit is configured to control said light-emitting device to emit an optical signal.

7. The optical device according to claim 1, wherein said optical device is integrated in an optically transmissive medium such that optical signals may be received from all directions by said light-receiving device and such that optical signals may be emitted in all directions by said light-emitting device.

8. The optical device according to claim 1, wherein said optical device is integrated in a casing comprising an optically opaque portion arranged such that optical signals may be prevented from being received from at least one direction and such that optical signals may be prevented from being emitted in at least one direction.

9. A system comprising a plurality of optical devices according to claim 7, being arranged adjacent to each other in a housing.

10. A system comprising a plurality of optical devices according to claim 1, arranged such that an optical signal may propagate unguided from a first optical device to a second optical device.

11. The plurality of optical devices according to claim 10, arranged such that an optical signal may propagate unguided from said first optical device to a second optical device through a third optical device.

12. A method of controlling an optical device comprising:
an optically transmissive light-emitting device configured to allow at least portion of an optical signal to be transmitted through said optically transmissive light-emitting device;
an optically transmissive light-receiving device, wherein said optical signal is received by said optically transmissive light-receiving device and at least a portion of said optical signal is transmitted through said optically transmissive light-receiving device;
an optically transmissive storage device; and
an optically transmissive control unit electrically connected to and configured to control said light-emitting device, said light-receiving device and said storage device, said optically transmissive control unit and said optically transmissive storage device being configured to allow at least a portion of said optical signal to pass through the optically transmissive control unit and said optically transmissive storage device;
said method comprising the steps of:
receiving an optical signal comprising an address identifying a second optical device;
determining if said address identifying a second optical device correspond to an address stored in said storage device; and
if said address corresponds to said address stored in said storage device, incrementing a property value based on a weight of said received optical signal.

13. The method according to claim 12, wherein, if said property value exceeds a threshold value, controlling said light-emitting device to emit an optical signal.
